(19) United States
(12) Patent Application Publication
(10) Pub. No.: US 2005/0018241 A1
(43) Pub. Date: Jan. 27, 2005

(54) Network print system and printer

(75) Inventor: Osamu Azami, Nagano (JP)

Correspondence Address: HOGAN & HARTSON L.L.P., 500 S. GRAND AVENUE, SUITE 1900, LOS ANGELES, CA, 90071-2611, US

(73) Assignee: SEIKO EPSON CORPORATION

(21) Appl. No.: 10/864,282

(22) Filed: Jun. 9, 2004

(30) Foreign Application Priority Data
Jun. 9, 2003 (JP) P.2003-163735

(51) Int. Cl. G06F 15/00; G06F 15/16

(52) U.S. Cl. 358/1.15; 709/203

(57) ABSTRACT

The present invention aims to provide a network print system including a plurality of printers, wherein the communication traffic for collecting information is small and a setting change job of a computer for collecting job information, etc., is also easy to conduct. The network print system comprises a plurality of printers and a printer management computer. Each of the printers making up a network print system has a function of transmitting a report concerning the state of the own printer and the state of a different printer to a specified computer in accordance with a specified schedule. The printer not printing among the printers transmits the report.

### BACKGROUND OF THE INVENTION

1. Field of the Invention

This invention relates to a printer connected to a network for use and a network print system including a plurality of printers connected to a network.

2. Description of the Related Art

As a network system including a plurality of printers connected, used in an office, etc., which will be hereinafter referenced to as network print system, a network print system is known wherein a program for collecting job information, consumable information, and error/warning information from each printer is installed in a computer contained in the system, whereby the printers can be managed in the computer (for example, patent document 1: JP-A-2000-309147). A network print system is also known wherein a computer (print server) having a function of relaying print job data from each host computer to each printer is installed and is also provided with a function of managing job information and a function of collecting and managing consumable information and error/warning information from each printer.

The described network print system makes it possible to manage the printers in one computer, so that the printers can be managed easily.

However, the described network print system requests each printer to output job information, etc., and therefore the communication traffic for collecting information is comparatively large. After the program for collecting job information, etc., is installed in the computer, various setting jobs must be executed and therefore the job at the startup time and the change job of the computer for collecting job information, etc., are also cumbersome to a considerable extent.

### SUMMARY OF THE INVENTION

It is therefore an object of the invention to provide a network print system including a plurality of printers, wherein the communication traffic for collecting information is small and a special setting job need not be conducted for a computer for collecting job information, etc.

It is another object of the invention to provide printers for making it possible to construct such a network print system.

To the ends, according to a first aspect of the invention, there is provided a network print system including a first-kind printer, one or more second-kind printers, and a printer management computer, wherein the second-kind printer is an apparatus including a request response section for returning printer state information representing an own state at the point in time to an apparatus transmitting predetermined request information, and wherein the first-kind printer is an apparatus including an information storage section for storing transmission schedule information for specifying a transmission schedule of printer state management information, information representing the state of the own printer and the state of each of the one or more second-kind printers, and address information of each of the one or more second-kind printers; and a printer state management information transmission section for repeating processing of acquiring the printer state information from the second-kind printer determined by the address information stored in the information storage section by transmitting the predetermined request information, creating the printer state management information based on the acquired printer state information and printer state information concerning the own printer, and transmitting the printer state management information to the printer management computer in accordance with the transmission schedule specified in the transmission schedule information stored in the information storage section.

In the described network print system according to the first aspect of the invention, the printer state information concerning each printer is transmitted to the printer management computer based on the schedule specified in the transmission schedule information. Therefore, the network print system functions as a system wherein various setting jobs including installation of a program for collecting information from the printers need not be conducted for the printer management computer.

To implement the network print system according to the first aspect of the invention, it is desirable that the printer state management information transmission section should transmit text information as the printer state management information. The reason is as follows: If the printer state management information is any information other than text information, the parties to which the printer state management information is to be transmitted are limited to only computers capable of displaying the information (or a program for displaying the information needs to be installed in the computer to which the printer state management information is to be transmitted); whereas, if the printer state management information is text information, almost all computers can display text information and therefore the parties to which the printer state management information is to be transmitted are not limited (a program for displaying the information needs not be installed in the computer to which the printer state management information is to be transmitted).

To implement the network print system according to the first aspect of the invention, it is desirable that the printer state management information transmission section should transmit files generated on a printer-by-printer basis as the printer state management information to facilitate information management in the computer. It is desirable that the printer state management information transmission section should enable the user to select the protocol used to transmit the printer state management information from among protocols so that the computers to which the printer state management information is to be transmitted are not limited.

According to a second aspect of the invention, there is provided a network print system including a plurality of printers and a printer management computer, wherein each of the plurality of printers is an apparatus including a printer state information return section for returning printer state information, information representing the own state at the point in time, to an apparatus transmitting predetermined request information; and a printer state management information transmission section for acquiring the printer state information from each of other printers by transmitting the predetermined request information to the printer state information return section in each of other printers, and transmitting printer state management information, information responsive to the acquired printer state information and printer state information concerning the own printer, to the printer management computer, and wherein at least one printer further includes an operation control section for repeating control to cause only the printer state information transmission section in the printer not printing among the plurality of printers making up the system to operate in accordance with a specified transmission schedule.

That is, the network print system according to the second aspect of the invention is a system wherein one printer transmits the printer state management information (information equivalent to a set of the printer state information concerning the printers) to the printer management computer in accordance with the specified transmission schedule and the printer not printing transmits the printer state management information. Therefore, the network print system functions as a system wherein print processing is not delayed as processing for transmitting the printer state management information is performed.

To implement the network print system according to the second aspect of the invention, like the network print system according to the second aspect of the invention, it is desirable that the printer state management information transmission section should transmit text information as the printer state management information, transmit files generated on a printer-by-printer basis as the printer state management information, enable the user to select the protocol used to transmit the printer state management information from among protocols, or the like.

In the network print system according to the second aspect of the invention, the operation control section may be implemented using means for searching for a printer not printing and causing only the printer state information transmission section in the found printer to operate, each printer may be an apparatus including the operation control section, and the operation control section of each printer may be means for circulating processing description specification information indicating the date and time to cause the printer state information transmission section to operate among the operation control section of the plurality of printers, determining whether or not the own printer is processing print job data at the date and time indicated by the received processing description specification information, if the own printer is not processing print job data, causing the printer state information transmission section in the own printer to operate and then transferring processing description specification information indicating the next date and time to cause the printer state information transmission section to operate to another printer, and if the own printer is processing print job data, transferring the received processing description specification information to another printer.

According to the invention, there is provided a printer including:
a printer state information return section for returning printer state information representing the own state at the point in time, to an apparatus transmitting predetermined request information;
a printer state management information transmission section for acquiring the printer state information from each of other printers by transmitting the predetermined request information to each printer including printer state information return section, and transmitting printer state management information responsive to the acquired printer state information and printer state information concerning the own printer, to a printer management computer connected to a network; and
an operation control section for performing control to start operation of the printer state information transmission section,
wherein the operation control section circulates processing description specification information indicating the date and time to cause the printer state information transmission section to operate among the operation control section in other printers connected to the network, determines whether or not the own printer is processing print job data at the date and time indicated by the received processing description specification information, if the own printer is not processing print job data, causes the printer state information transmission section in the own printer to operate and then transfers processing description specification information indicating the next date and time to cause the printer state information transmission section to operate to another printer, and if the own printer is processing print job data, transfers the received processing description specification information to another printer.

Therefore, if the several printers are connected to the network, a system equivalent to the network print system according to the second aspect of the invention can be implemented.

### BRIEF DESCRIPTION OF THE DRAWINGS

In the Accompanying Drawings:

FIG. 1 is a drawing to show the configuration of a printer according to a first embodiment of the invention;

FIG. 2 is a schematic representation of a report transmission condition set page that the printer according to the first embodiment of the invention causes a computer to display;

FIG. 3 is a schematic representation of a managed printer set page that the printer according to the first embodiment of the invention causes a computer to display;

FIG. 4 is a flowchart of report transmission processing executed in the printer according to the first embodiment of the invention;

FIG. 5 is a flowchart of report transmission processing executed in the printer according to the first embodiment of the invention;

FIG. 6 is a flowchart of report transmission processing executed in the printer according to the first embodiment of the invention;

FIGS. 7A and 7B are schematic representations of a network print system that can be constructed using the printer according to the first embodiment of the invention;

FIG. 8 is a schematic representation of a network print system that can be constructed using the printer according to the first embodiment of the invention;

FIG. 9 is a drawing to show the configuration of a printer according to a second embodiment of the invention;

FIGS. 10A and 10B are schematic representations of a network print system that can be constructed using the printer according to the second embodiment of the invention;

FIG. 11 is a schematic representation of an information collection ticket transmitted and received between the printers according to the second embodiment of the invention;

FIG. 12 is a flowchart of master report transmission processing executed in the printer according to the second embodiment of the invention;

FIG. 13 is a flowchart of ticket issuance processing executed in the printer according to the second embodiment of the invention;

FIG. 14 is a flowchart of master ticket transfer processing executed in the printer according to the second embodiment of the invention;

FIG. 15 is a flowchart of slave report transmission processing executed in the printer according to the second embodiment of the invention;

FIG. 16 is a flowchart of slave ticket transfer processing executed in the printer according to the second embodiment of the invention; and

FIG. 17 is a schematic representation of a network print system that can be constructed using the printers according to the second embodiment of the invention.

In the drawings, the reference numerals refers to followings:
10, 50 Printer;
11, 51 Control section;
12, 52 Operation panel; and
13, 53 Print mechanism section.

### DETAILED DESCRIPTION OF THE PREFERRED EMBODIMENTS

Referring now to the accompanying drawings, there are shown preferred embodiments of the invention.

<First Embodiment>

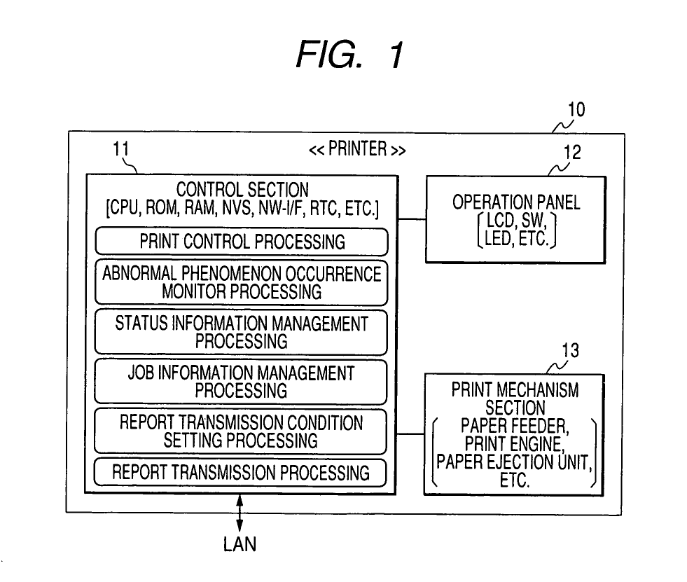

A printer 10 according to a first embodiment of the invention includes a control section 11 made up of a CPU, ROM, RAM, NVS (nonvolatile storage: HDD, RAM with battery backup, or the like), an NW I/F (network interface circuit), an RTC (real-time clock), etc., an operation panel 12 made up of a liquid crystal display (LCD), a plurality of pushbutton switches (SWs), a plurality of light emitting diodes (LEDs), etc., and a print mechanism section 13 made up of a paper feeder, a print engine, a paper ejection unit, etc., as schematically shown in FIG. 1. The printer 10 also includes a unit for concurrently executing print control processing, abnormal phenomenon occurrence monitor processing, status information management processing, job information management processing, report transmission condition information setting processing, report transmission processing, etc., as the control section 11.

In the embodiment, the printer 10 corresponds to a first-kind printer contained in a network print system as claimed in claims 1 to 4, a selectable printer (described later) corresponds to a second-kind printer, the NVS corresponds to an information storage section, the portion of the control section 11 for performing report transmission processing corresponds to a printer state management information transmission section, and several reports of the same kind transmitted at the same timing by the report transmission processing correspond to printer state management information.

The print control processing executed by the control section 11 is processing of monitoring reception of print job data and causing the print mechanism section 13 to generate printed matter specified in the received print job data. The abnormal phenomenon occurrence monitor processing is processing of monitoring occurrence of an abnormal phenomenon in the printer 10 and if an abnormal phenomenon occurs, displaying a message indicating occurrence of the abnormal phenomenon on the operation panel 12 (LCD), etc. The status information management processing is processing of managing the remaining amounts of the consumables in the printer 10, the number of times the periodical replacement parts have been used, the user-setup values concerning various operation condition items, and the like (status information).

The job information management processing includes processing of storing (recording) job information concerning print job data processed by the print control processing (information made up of various pieces of item information such as the transmission source computer name, the number of print sheets, and the print date and time) in the NVS (nonvolatile storage) in the control section 11 and processing for making a response to a job information output request issued by a different apparatus.

The report transmission condition setting processing is processing of changing error report transmission condition information, status report transmission condition information, job report transmission condition information, and managed printer information stored in the NVS to those as specified by the manager of the printer 10.

Specifically, the control section 11 executing the report transmission condition setting processing usually monitors reception of a set page request, report transmission condition specification information, a managed printer selection page request, and managed printer specification information.

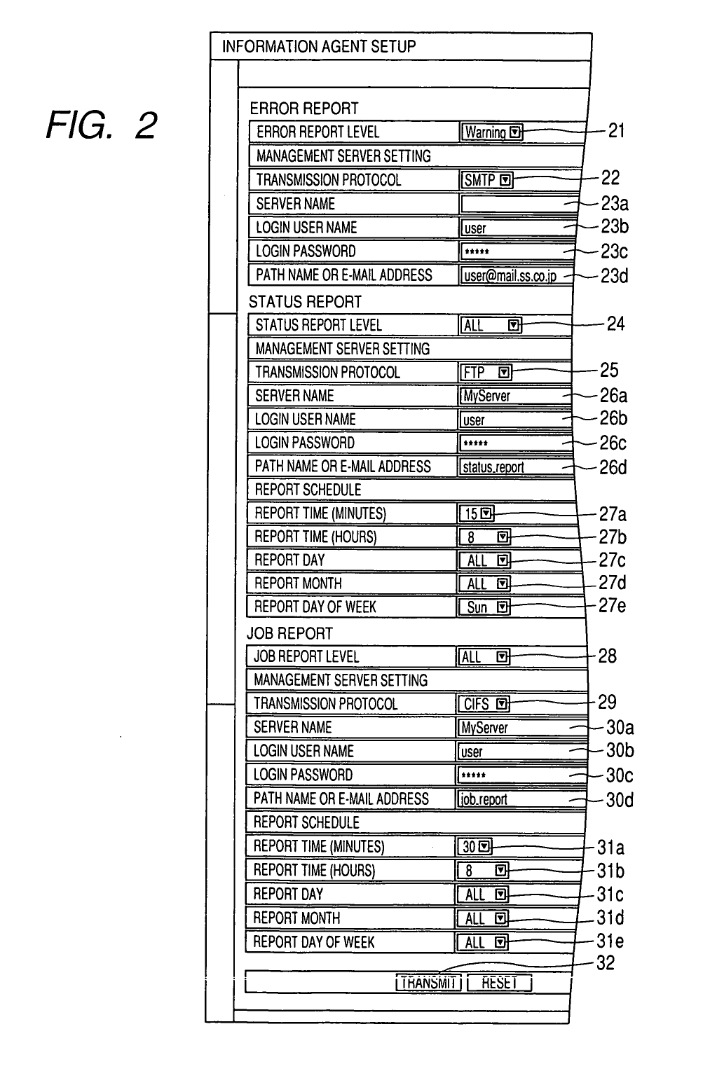

The set page request whose reception is monitored by the control section 11 is an HTTP request of a predetermined description. Upon reception of the set page request, the control section 11 causes the computer transmitting the set page request to display a report transmission condition set page in the format shown in FIG. 2.

The report transmission condition set page is a Web page where the initial values of select boxes 21, 22, 24, 25, 27a to 27e, 28, 29, and 31a to 31e and text boxes 23a to 23d, 26a to 26d, and 30a to 30d are those responsive to the error report transmission condition information, the status report transmission condition information, and the job report transmission condition information stored in the NVS. The report transmission condition set page is a Web page where the information received by the control section 11 containing the current values in the items (containing the values set by the manager of the printer 10) is transmitted to the network when the user presses a TRANSMIT button 32.

The information transmitted as the TRANSMIT button 32 is pressed is the report transmission condition specification information. Upon reception of the report transmission condition specification information, the control section 11 changes the error report transmission condition information, the status report transmission condition information, and the job report transmission condition information stored in the NVS to those responsive to the report transmission condition specification information.

The transmission condition information rewritten by performing the processing will be discussed instead of describing the processing in detail.

The error report transmission condition information is information containing error report level information, error report transmission protocol specification information, error report destination specification information, and error report authentication information.

The error report level information contained in the error report transmission condition information is information specifying the condition to transmit an error report (a file retaining information indicating what error/warning occurred in the printer 10 (described later in detail)) according to the type of abnormal phenomenon (error/warning). The error report level information is information corresponding to the setup value in the select box 21 and can take a value specifying transmission of an error report when an error or a warning occurs, a value specifying transmission of an error report only when an error occurs (suppressing transmission of an error report when a warning occurs), or a value specifying transmission of no error report (non-transmission indication value).

The error report transmission protocol specification information is information specifying the protocol to be used to transmit an error report. The error report transmission protocol specification information is information corresponding to the setup value in the select box 22 and takes any of a value indicating transmission of an error report using FTP (File Transfer Protocol), a value indicating transmission of an error report using CIFS (Common Internet File System), or a value indicating transmission of an error report using SMTP (Simple Main Transfer Protocol).

The error report destination specification information is information specifying the destination of an error report. The error report destination specification information is information corresponding to the setup values in the text boxes 23a and 23d. The error report authentication information is information required for the receiving party at the destination to receive the error report and may be information containing no significant information. The error report authentication information is information corresponding to the setup values in the text boxes 23b and 23c.

On the other hand, the status report transmission condition information is information containing status report level information, status report transmission protocol specification information, status report destination specification information, status report authentication information, and status report schedule specification information.

The status report level information contained in the status report transmission condition information is information specifying the type of status information (information managed in the status information management processing) to be contained in a status report to be transmitted (a file containing various pieces of status information indicating the state of the printer 10 (described later in detail)). The status report level information is information corresponding to the setup value in the select box 24 and can take a non-transmission indication value specifying transmission of no status report like the error report level information.

The status report transmission protocol specification information is information specifying the protocol to be used to transmit a status report. The status report transmission protocol specification information is information corresponding to the setup value in the select box 25 and takes any of a value indicating transmission of a status report using FTP, a value indicating transmission of a status report using CIFS, or a value indicating transmission of a status report using SMTP like the error report transmission protocol specification information.

The status report destination specification information is information specifying the destination of a status report. The status report destination specification information is information corresponding to the setup values in the text boxes 26a and 26d. The status report authentication information is information required for the receiving party at the destination to receive the status report and may be information containing no significant information. The status report authentication information is information corresponding to the setup values in the text boxes 26b and 26c. The status report schedule specification information is information to specify the transmission schedule of a status report. The status report schedule specification information is information corresponding to the setup values in the select boxes 27a to 27e.

The job report transmission condition information is information containing job report level information, job report transmission protocol specification information, job report destination specification information, job report authentication information, and job report schedule specification information.

The job report level information contained in the job report transmission condition information is information corresponding to the setup value in the select box 28 to specify what item information of job information to be transmitted as a job report (a file containing job information recorded by performing the job information management processing (described later in detail)). The job report level information can take a non-transmission indication value specifying transmission of no job report like the error report level information and the status report level information.

The job report transmission protocol specification information is information corresponding to the setup value in the select box 29 to specify the protocol to be used to transmit a job report. The job report transmission protocol specification information also takes any of a value indicating transmission of a job report using FTP, a value indicating transmission of a job report using CIFS, or a value indicating transmission of a job report using SMTP like any other transmission protocol specification information.

The job report destination specification information is information corresponding to the setup values in the text boxes 30a and 30d to specify the destination of a job report. The job report authentication information is information required for the receiving party at the destination to receive the job report and may be information containing no significant information. The job report authentication information is information corresponding to the setup values in the text boxes 30b and 30c. The job report schedule specification information is information corresponding to the setup values in the select boxes 31a to 31e to specify the transmission schedule of a job report.

On the other hand, the managed printer selection page request whose reception is monitored by the control section 11 performing report transmission condition setting processing is an HTTP request of a predetermined description different from the set page request.

Upon reception of the managed printer selection page request, the control section 11 first performs processing of examining the model name, the MAC address, the IP address, etc., of each printer (selectable printer) manufactured by the same manufacturer as the own printer 10, existing on the same LAN (broadcast domain) as the own printer 10. Every selectable printer is an apparatus which supports the SNTP and can transmit a trap notification when a warning occurs and a trap notification when an error occurs. Some selectable printers (selectable printers of specific models) have a function of recording job information and responding to various requests concerning job information (mainly, job information output request) from a different apparatus.

The control section 11 examining the model name, the MAC address, the IP address, etc., of each selectable printer performs managed printer set page providing processing for providing a managed printer set page for the computer transmitting a set page request, which will be hereinafter referred to as communicating computer.

More particularly, the control section 11 creates source data (HTML data) responsive to the examination information and the managed printer specification information stored in the NVS and transmits the source data to the communicating computer as the managed printer set page providing processing.

The managed printer specification information referenced at the time of the managed printer set page providing processing is information containing information made up of the model name, the MAC address, and the IP address, which will be hereinafter referred to as managed printer determination information, for each of one or more managed printers (printers selected by the manager from among the selectable printers (described later in detail)).

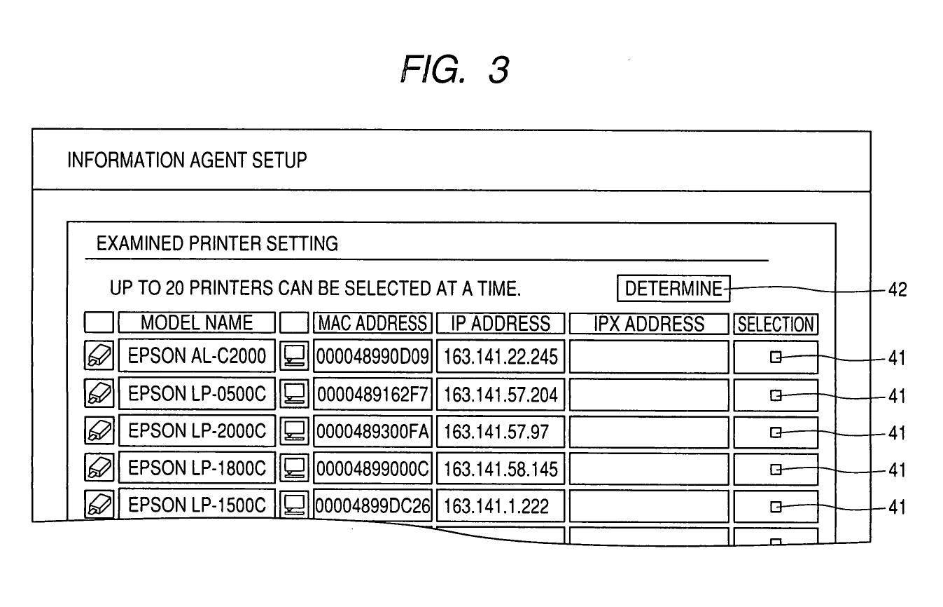

On the other hand, the managed printer set page provided by performing the managed printer set page providing processing is a Web page displaying a SET button 42 and is also a Web page displaying the model name, the MAC address, a check box 41, etc., for each selectable printer, as shown in FIG. 3.

Each check box 41 displayed on the managed printer set page is an item to select the selectable printer corresponding to the check box as the managed printer. In the managed printer set page providing processing, the managed printer specification information is referenced and the initial value of each check box 41 is determined.

The SET button 42 on the managed printer set page is an item for the communicating computer (Web browser) to transmit information containing the current value of each check box 41 (information indicating whether or not the check box is checked) and received by the control section 11 to the network as the user presses the SET button 42.

The information transmitted as the user presses the SET button 42 is managed printer set indication information. Upon reception of the managed printer set indication information, the control section 11 changes the managed printer set specification information stored in the NVS to that responsive to the managed printer set indication information.

On the other hand, the report transmission processing executed by the control section 11 is processing of transmitting an error report, a status report, a job report in the conditions indicated by the error report transmission condition information, the status report transmission condition information, the job report transmission condition information as described above and is also processing again executed if the error, status, or job report transmission condition information is changed.

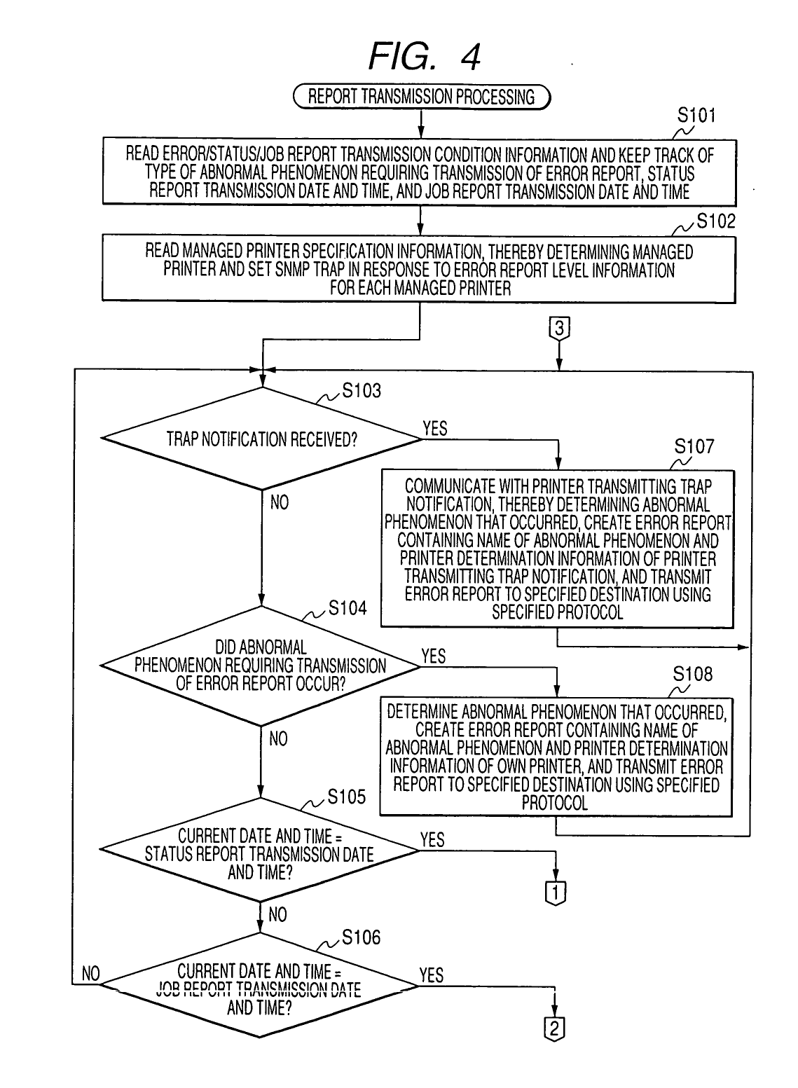

FIGS. 4 to 6 are flowcharts to show the report transmission processing executed by the control section 11.

As shown in FIG. 4, the control section 11 starting the report transmission processing first reads the error report transmission condition information, the status report transmission condition information, and the job report transmission condition information stored in the NVS into the RAM and keeps track of the type of abnormal phenomenon (error or warning) to transmit an error report, the date and time to transmit a status report (status report transmission date and time), and the date and time to transmit a job report (job report transmission date and time) (step S101). More particularly, the control section 11 performs the following processing at step S101:

First, the control section 11 reads the error report transmission condition information, the status report transmission condition information, and the job report transmission condition information stored in the NVS into the RAM. Then, the control section 11 performs processing of determining and storing the type of abnormal phenomenon to transmit an error report based on error report level information (element information of the error report transmission condition information) read into the RAM, processing of determining the next transmission date and time of a status report (the transmission date and time of the first status report to be transmitted after execution of step S101) based on status report transmission schedule specification information (element information of the status report schedule specification information) read into the RAM and the current date and time (output of the RTC) and storing the transmission date and time as the status report transmission date and time, and processing of determining the next transmission date and time of a job report (the transmission date and time of the first job report to be transmitted after execution of step S101) based on job report transmission schedule specification information (element information of the job report schedule specification information) read into the RAM and the current date and time (output of the RTC) and storing the transmission date and time as the job report transmission date and time.

The control section 11 performing the processing at step S101 reads the managed printer specification information into the RAM and sets SNMP trap in response to the error report level information for the managed printer determined by the managed printer determination information for each piece of managed printer determination information contained in the managed printer specification information (step S102).

That is, if the error report level information is to specify transmission of an error report when an error or a warning occurs, at step S102, the control section 11 makes setting to cause each managed printer to transmit a trap notification representing occurrence of an error or a trap notification representing occurrence of a warning to the own printer 10. If the error report level information is to specify transmission of an error report when an error occurs, the control section 11 makes setting to cause each managed printer to transmit a trap notification representing occurrence of an error to the own printer 10. If the error report level information is to specify transmission of no error report, the control section 11 makes setting to cause each managed printer not to transmit a trap notification representing occurrence of an error or a warning to the own printer 10.

Upon completion of the processing at step S102, the control section 11 starts monitor processing of reception of a trap notification, detection of an abnormal phenomenon (error/warning) to transmit an error report in abnormal phenomenon occurrence monitor processing, and the current date and time matching the status report date and time or the job report date and time (loop process made up of steps S103 to S106). Although not shown in the flowchart, the control section 11 also determines whether or not the level information concerning each report takes the non-transmission indication value at step S101. If a report whose level information takes the non-transmission indication value exists, the control section 11 executes the loop process at steps S103 to S106 while skipping the determination as to the report whose level information takes the non-transmission indication value.

Upon detection of reception of a trap notification in the loop process made up of steps S103 to S106 (YES at step S103), the control section 11 performs the following processing at step S107:

First, the control section 11 acquires information indicating what the abnormal phenomenon occurring in the managed printer is from the managed printer transmitting the trap notification. The control section 11 acquires the information by SNMP. Next, the control section 11 creates a text file containing the printer determination information and the name of the abnormal phenomenon that occurred and having the file name listing a predetermined character string (a character string to indicate that the file is an error report from the file name), the model name, the IP address, and the current date and time based on the acquired information, the managed printer determination information of the managed printer (model name, MAC address, IP address), and the current date and time. If the protocol specified by the error report transmission protocol specification information is FTP or CIFS, the control section 11 transmits the created error report (text file) to the destination specified by the error report destination specification information (if necessary, using the error report authentication information). On the other hand, if the protocol specified by the error report transmission protocol specification information is SMTP, the control section 11 transmits electronic mail with information equivalent to the above-mentioned file name set as “subject” to which the created error report (text file) is attached to the destination specified by the error report destination specification information using the error report authentication information.

The control section 11 performing the processing at step S107 starts processing at step S103 and again enters the state of monitoring occurrence of various events.

Upon detection of occurrence of an abnormal phenomenon to transmit an error report in the own printer 10 (YES at step S104), the control section 11 performs almost the same processing as that at step S107 (processing using the information managed in the own printer (control section) rather than the information obtained from a different printer) at step S108 and then again starts the loop process at steps S103 to S106.

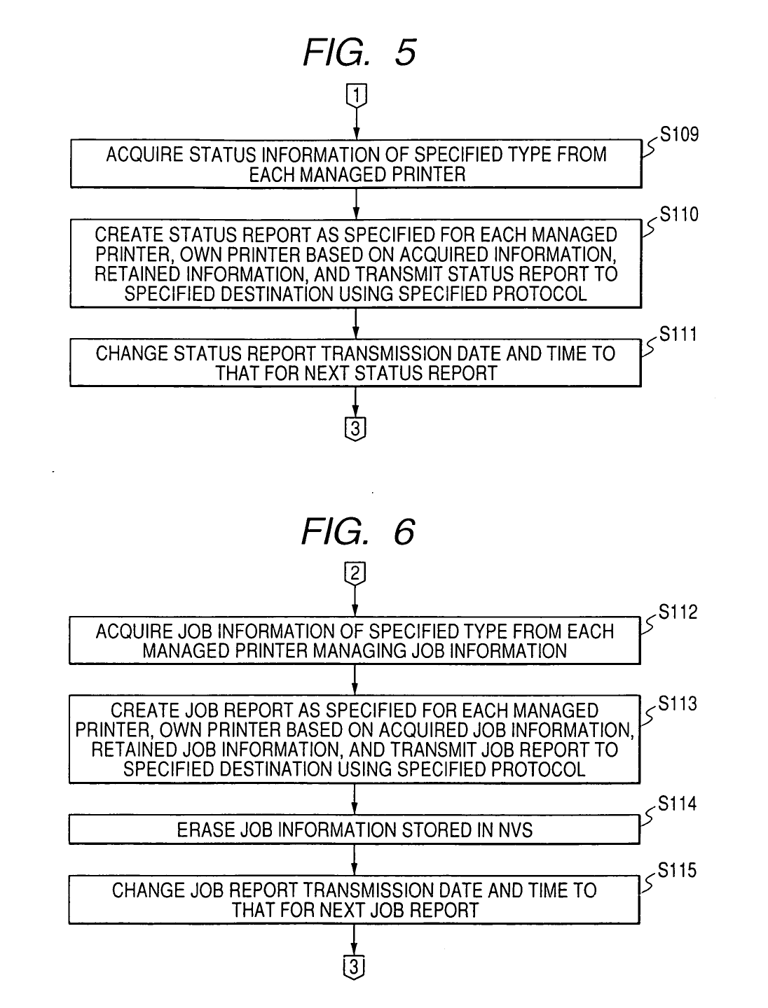

If the current date and time matches the status report transmission date and time (YES at step S105), the control section 11 first acquires status information of the type specified by the status report level information by SNTP from each managed printer (step S109) as shown in FIG. 5. Next, for each managed printer, the control section 11 creates a status report from the status information acquired from the managed printer, the managed printer determination information of the managed printer, and the like and transmits the status report to the specified destination and for the own printer, the control section 11 creates a status report from the status information retained (managed) by the control section (own printer), the printer determination information of the own printer, and the like and transmits the status report to the specified destination (step S110).

At step S110, created as a status report is a text file containing printer determination information (information made up of the model name, the MAC address, and the IP address) on the first row (rows are information units separated by line feed) and text information status information of the types specified by the status report level information together with the names, such as “total number of print sheets: xxxxx” and “toner remaining amount: −yy%,” on the second and later rows and having the file name listing a predetermined character string (a character string to indicate that the file is a status report from the file name), the model name, the IP address, and the current date and time. At step S110, as at step S107 or S108 (processing for error report transmission), if the protocol specified by the status report transmission protocol specification information is FTP or CIFS, the created status report (text file) is transmitted to the specified destination; if the protocol specified by the status report transmission protocol specification information is SMTP, electronic mail with information equivalent to the above-mentioned file name set as “subject” to which the created status report (text file) is attached is transmitted to the specified destination.

Upon completion of transmission of the status report (at step S106), the control section 11 changes the status report transmission date and time to the transmission date and time of the next status report based on the status report transmission schedule information (step S111) and then again starts processing at step S103 (FIG. 4).

If the current date and time matches the job report transmission date and time (YES at step S106), the control section 11 first acquires job information stored in the managed printer from each managed printer having a function of managing job information (step S112) as shown in FIG. 6. At step S112, whether or not each managed printer has the function of managing job information is determined from the model name of the printer and job information is not left in each managed printer.

Next, at step S113, for each managed printer, the control section 11 creates a job report from the job information acquired from the managed printer, the managed printer determination information of the managed printer, and the like and transmits the job report to the specified destination and for the own printer, the control section 11 creates a job report from the job information retained (managed) by the control section (own printer) (job information stored in the NVS by performing job information management processing), the printer determination information of the managed printer, and the like and transmits the job report to the specified destination.

At step S113, created as a job report is a text file in CSV (Comma Separated Value) format containing printer determination information on the first row, job information (containing only item information responsive to the job report level information) on the third and later rows, and the names of the item information of the job information contained on the third and later rows on the second row and having the file name listing a predetermined character string (a character string to indicate that the file is a job report from the file name), the model name, the IP address, and the current date and time. At step S113, as at step S107, S108, or S110, if the protocol specified by the job report transmission protocol specification information is FTP or CIFS, the created status report (text file) is transmitted to the specified destination; if the protocol specified by the job report transmission protocol specification information is SMTP, electronic mail with information equivalent to the above-mentioned file name set as “subject” to which the created job report (text file) is attached is transmitted to the specified destination.

Upon completion of the processing at step S113, the control section 11 deletes the job information stored in the NVS (step S114) and changes the job report transmission date and time to the transmission date and time of the next job report based on the job report transmission schedule information and the current date and time (step S115) and then again starts processing at step S103.

As described above, the printer 10 according to the first embodiment is an apparatus that can autonomously transmit the three types of reports containing the information concerning the state of the apparatus and the state of each different printer (managed printer) to the specified apparatus according to the error, status, and job report destination specification information and also enables the user to select the transmission protocol of each report from among FTP, CIFS, and SMTP. Further, the printer 10 is an apparatus for transmitting as each report a text file not requiring any special program to view the contents of the report.

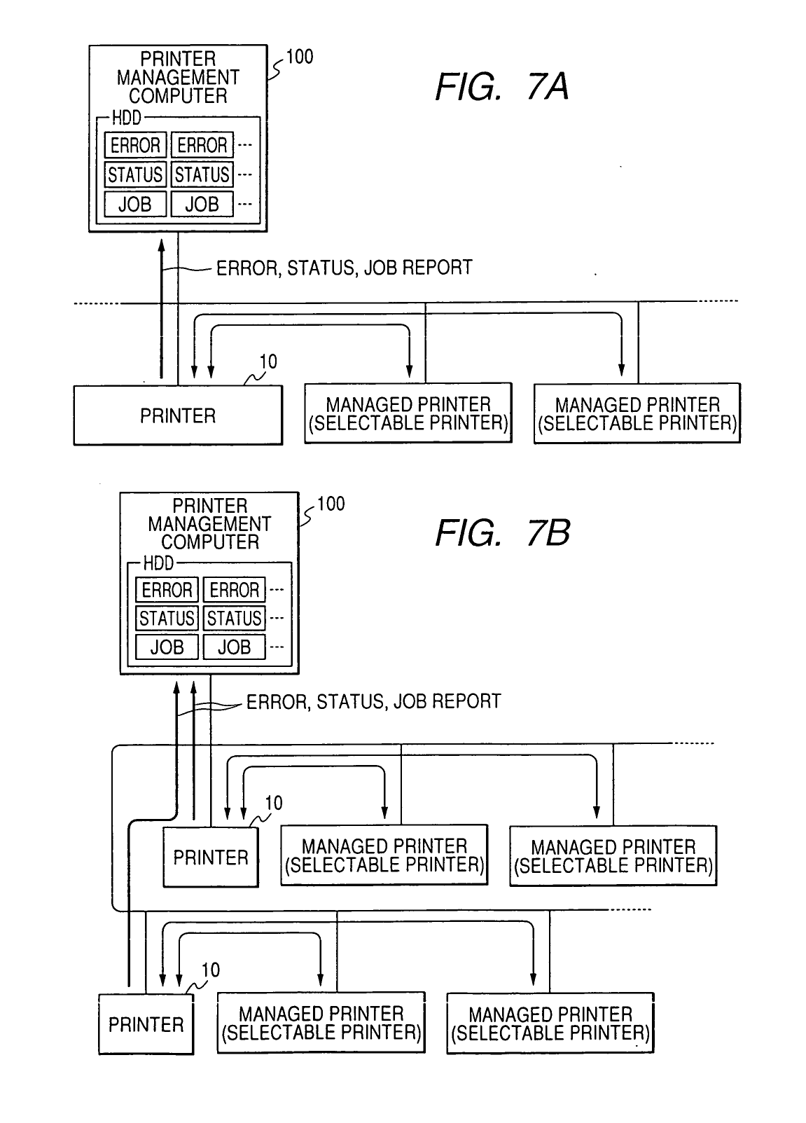

Therefore, as the printer 10 is used, a system wherein error reports, status reports, and job reports to enable the user to keep track of the state of the printer 10 and the state of each managed printer are retained (a system wherein several printers 10 and several selectable printers can be managed using a printer management computer 100) can be constructed in the printer management computer 100 with a usual computer (a computer that can receive information using any of FTP, CIFS, or FTP) used intact as the printer management computer 100 (without installing an information collection program), as shown in FIGS. 7A and 7B.

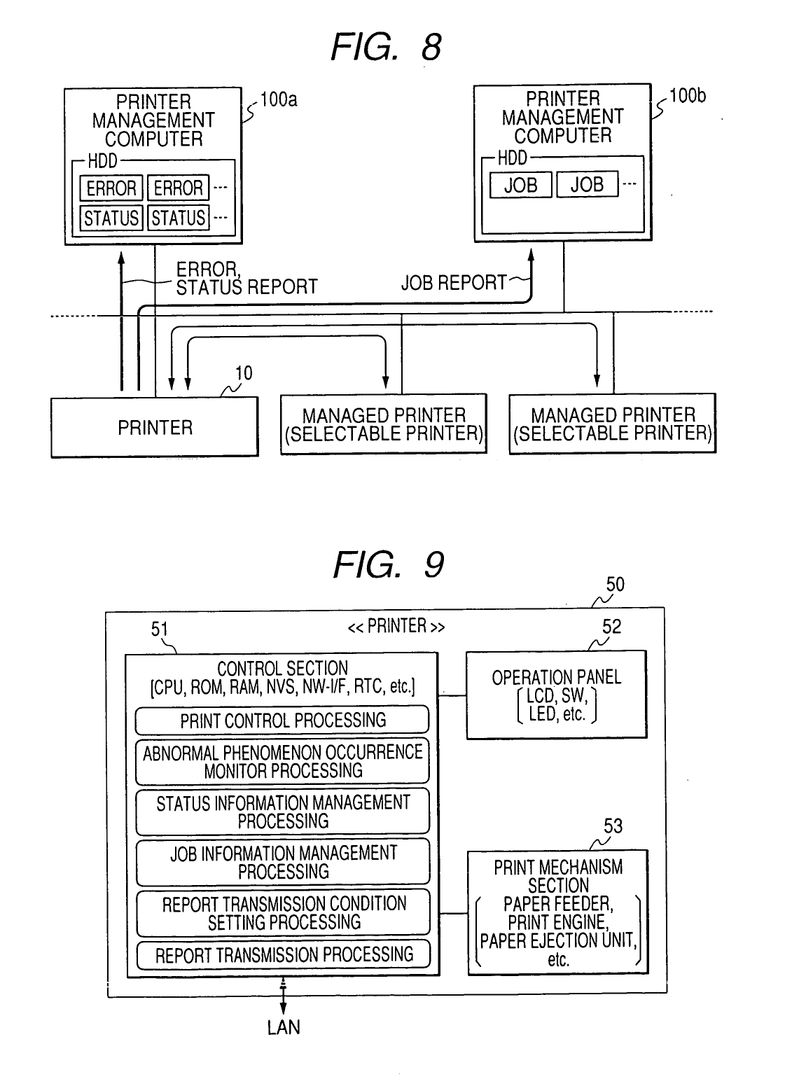

The printer 10 is an apparatus for enabling the user to specify the report destination for each type of report. As the printer 10 is used, a system as schematically shown in FIG. 8, namely, a system wherein error reports and status reports concerning the printer 10 and each managed printer are retained in a printer management computer 100a and job reports concerning the printer 10 and each managed printer are retained in a printer management computer 100b, so that management for causing the printer 10 to operate in the normal state can be conducted using the printer management computer 100b and charging management can be conducted using the printer management computer 100a can also be constructed with usual computers used intact as the printer management computers 100a and 100b.

<Second Embodiment>

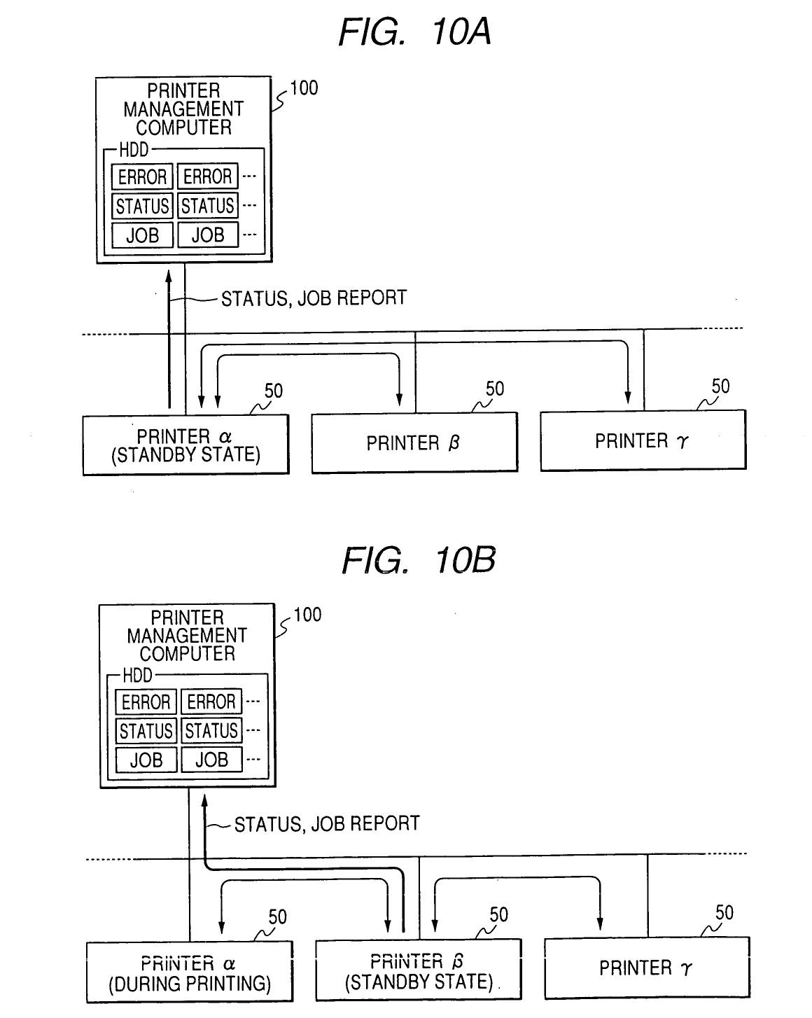

A printer 50 according to a second embodiment of the invention is outlined with FIGS. 9 and 10.

The printer 50 according to the second embodiment of the invention includes a control section 51 made up of a CPU, ROM, RAM, NVS (nonvolatile storage: HDD, RAM with battery backup, or the like), an NW I/F (network interface circuit), an RTC (real-time clock), etc., an operation panel 52 made up of a liquid crystal display (LCD), a plurality of pushbutton switches (SWs), a plurality of light emitting diodes (LEDs), etc., and a print mechanism section 53 made up of a paper feeder, a print engine, a paper ejection unit, etc., as schematically shown in FIG. 9. The printer 50 also includes a unit for concurrently executing print control processing, abnormal phenomenon occurrence monitor processing, status information management processing, job information management processing, report transmission condition information setting processing, report transmission processing, etc., as the control section 51.

The printers 50 make it possible to construct a network print system as schematically shown in FIGS. 10A, 10B. That is, the printers 50 make it possible to construct a network print system wherein error, status, and job reports concerning a plurality of printers 50 (similar to those transmitted by the printer 10 according to the first embodiment) are collected in one printer management computer 100 and status and job reports are transmitted from the printer 50 in a standby state to the printer management computer 100.

In the embodiment, the printer 50 corresponds to a printer contained in a network print system as claimed in claims 5 to 9 and a printer as claimed in claim 10, 11, the portions of the control section 51 for performing abnormal phenomenon occurrence monitor processing, status information management processing, and job information management processing correspond to a printer state information return section, the portion of the control section 51 for performing report transmission processing corresponds to a printer state management information transmission section and an operation control section, and an information collection ticket described later corresponds to processing description specification information.

Based on the description, the configuration and the operation of the printer 50 according to the second embodiment will be discussed furthermore specifically.

The print control processing, abnormal phenomenon occurrence monitor processing, status information management processing, and job information management processing executed by the control section 51 (see FIG. 9) in the printer 50 are the same as those executed by the control section 11.

The report transmission condition setting processing executed by the control section 51 is also the same as that executed by the control section 11 except that it may be unused to set status report transmission condition information, managed printer information, etc., (described later in detail).

The report transmission processing executed by the control section 51 is processing started when power of the printer 50 is turned on or when status report transmission condition information, etc., is changed. The different type of report transmission processing is executed depending on whether or not status report transmission condition information, managed printer information, etc., is stored in the NVS (setting of status report transmission condition information, managed printer information, etc., using the report transmission condition setting processing is performed).

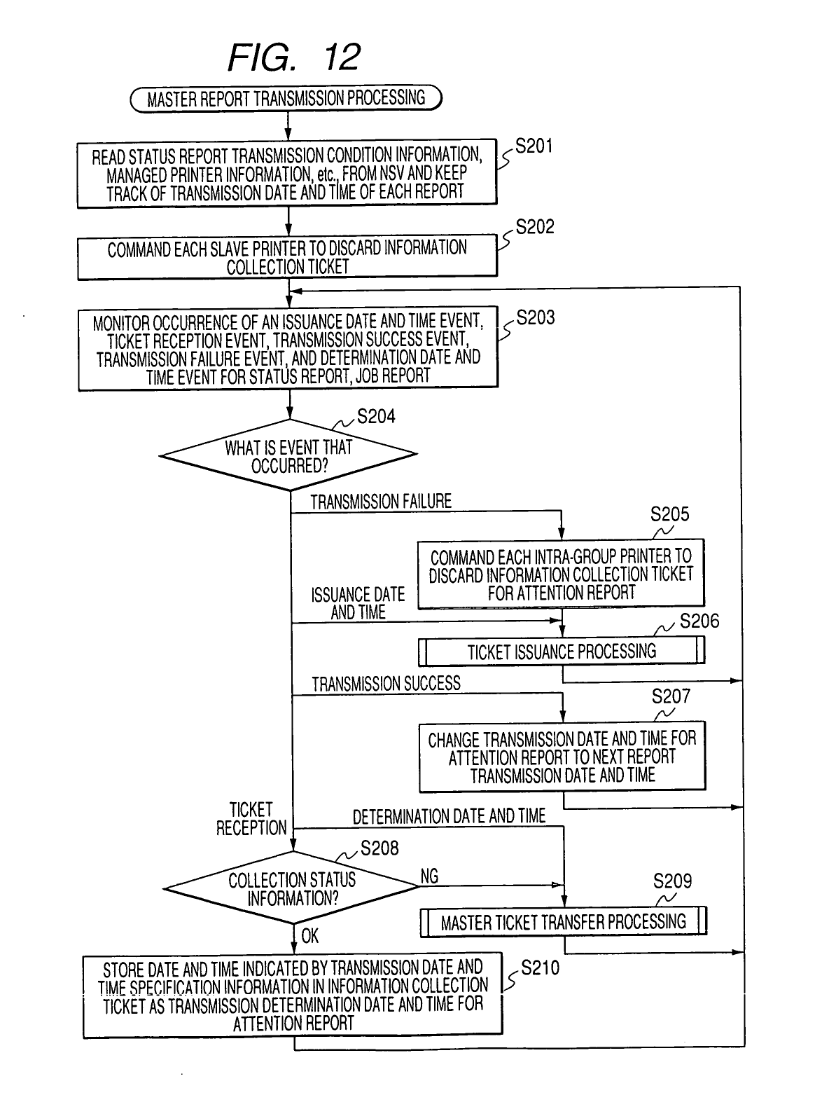

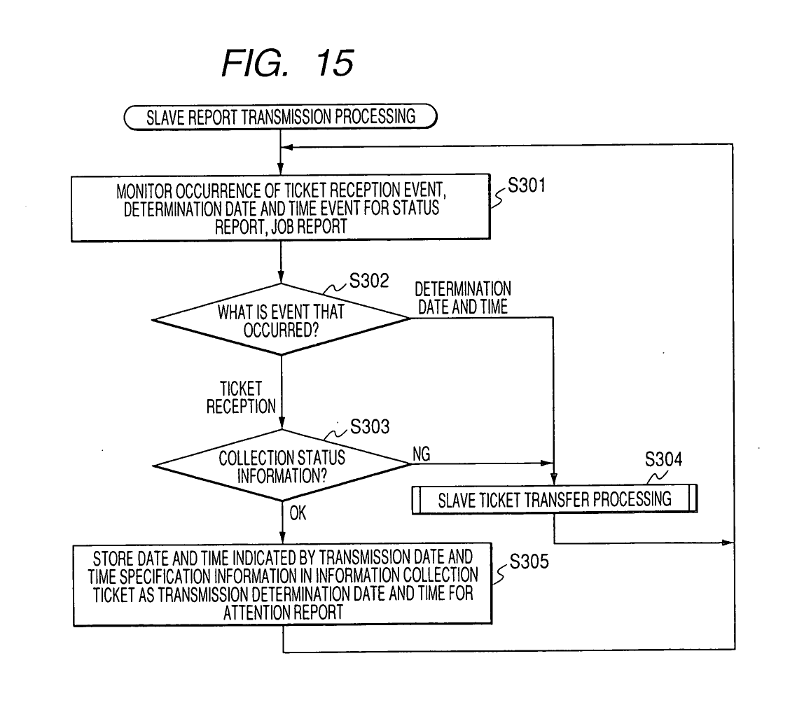

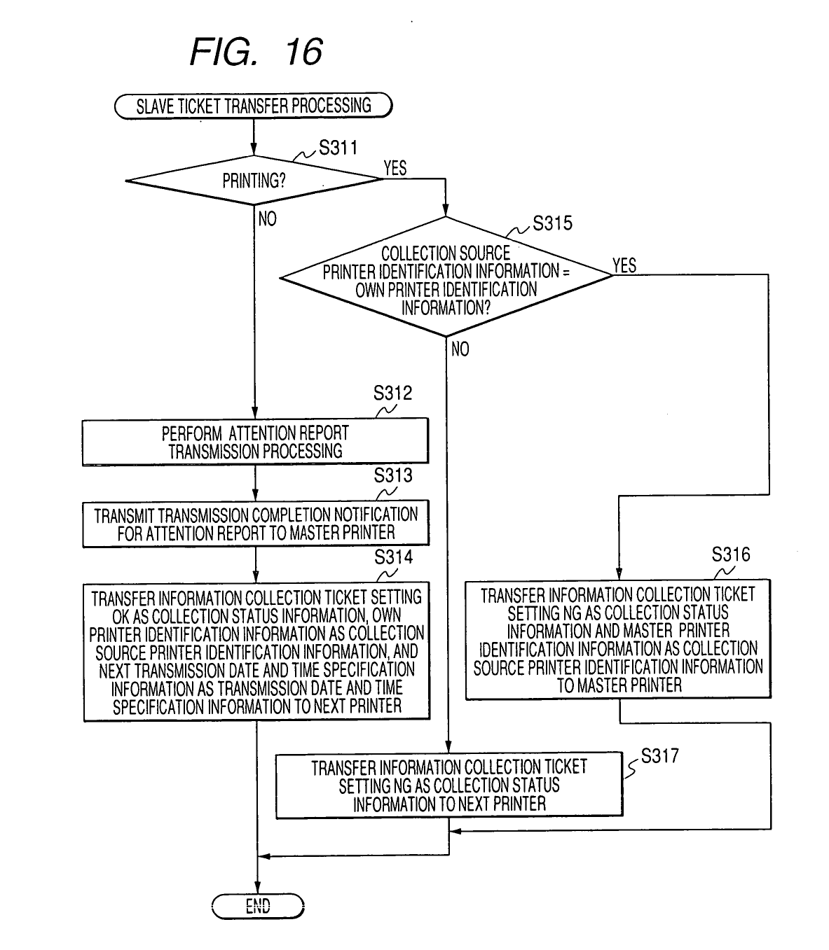

Specifically, the control section 51 starting report transmission processing when the power is turned on, etc., first determines whether or not status report transmission condition information, etc., is stored in the NVS of the control section 51. If status report transmission condition information, etc., is stored in the NVS, the control section 51 starts master report transmission processing shown in FIGS. 12 to 14; if status report transmission condition information, etc., is not stored in the NVS, the control section 51 starts slave report transmission processing shown in FIGS. 15 and 16.

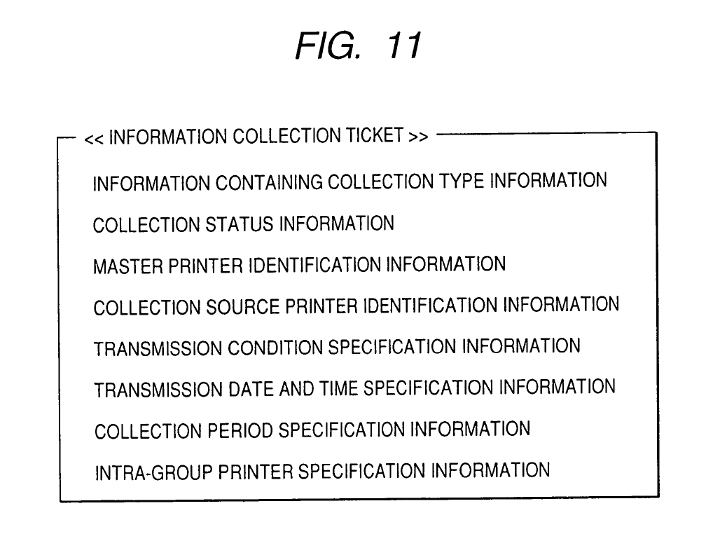

The structure of an information collection ticket, information generated by the control section 51 executing master report transmission processing and then circulated between the control sections 51 executing slave report transmission processing or master report transmission processing will be discussed with FIG. 11 before the master report transmission processing and the slave report transmission processing are described in detail.

In the description that follows, the printer 50 wherein the control section 51 executes the master report transmission processing is denoted as the master printer 50, and the printer 50 with printer determination information (information made up of model name, MAC address, and IP address; see the description of the managed printer set page providing processing according to the first embodiment) contained in managed printer information set for the master printer 50 is denoted as the slave printer 50.

The information collection ticket is information containing collection type information, collection status information, master printer identification information, collection source printer identification information, destination specification information, transmission date and time specification information, collection period specification information, and intra-group printer specification information, as shown in FIG. 11.

The collection type information, the master printer identification information, the collection source printer identification information, the destination specification information, the collection period specification information, and the intra-group printer specification information contained in the information collection ticket are information not rewritten while the information collection ticket is circulated; the collection status information, the collection source printer identification information, and the transmission date and time specification information are information which may be rewritten while the information collection ticket is circulated.

The collection type information is information indicating which of status and job reports the own information collection ticket concerns. A network print system constructed using the printers 50 according to the embodiment is a system wherein one information collection ticket for a status report (information collection ticket containing the collection type information indicating that the own information collection ticket concerns a status report) and one information collection ticket for a job report (information collection ticket containing the collection type information indicating that the own information collection ticket concerns a job report) are circulated (described later in detail).

The master printer identification information is printer identification information of the master printer 50 (information based on which communications with one printer can be conducted; in the embodiment, the IP address). The master printer identification information is information contained in the information collection ticket to make each slave printer 50 understand which printer 50 the master printer 50 is.

The intra-group printer specification information is information listing the printer determination information of the master printer 50 and the printer determination information of each slave printer 50. The intra-group printer specification information is information used for the control section 51 in each printer 50 to determine the destination of the information collection ticket and create a status report, a job report.

The transmission condition specification information is information corresponding to status report transmission condition information from which status report schedule specification information is excluded or job report transmission condition information from which job report schedule specification information is excluded. That is, the transmission condition specification information is information to provide the slave printer 50 in which status report transmission condition information, job report transmission condition information, etc., is not set with information specifying the type of information contained in the status report, the job report, information specifying the destination of the status report, the job report, and information required for the receiving party at the destination to actually receive the status report, the job report.

The collection period specification information is information indicating the status report, job report transmission period determined by the status report schedule specification information, job report schedule specification information. The transmission date and time specification information is information indicating the date and time at which status report, job report is to be transmitted. The transmission date and time specification information is information whose initial value is set by the master printer 50 (the control section 51 performing the master report transmission processing) based on the status report schedule specification information, job report schedule specification information. The printer 50 actually transmitting a status report or a job report (the control section 51 performing the slave report transmission processing or the master report transmission processing) rewrites the information by referencing the collection period specification information (adds the time indicated by the collection period specification information).

The collection status information is information in which the printer 50 actually transmitting a status report or a job report (the control section 51 performing the slave report transmission processing or the master report transmission processing) sets OK (change/overwrite) or the printer 50 not transmitting a status report or a job report because of printing (the control section 51 performing the slave report transmission processing or the master report transmission processing) sets NG (change/overwrite). The collection status information is information based on which the printer 50 (control section 51) receiving the information collection ticket determines whether or not the information collection ticket is to be processed at once (as described later in detail).

The collection source printer identification information is information rewritten by the printer 50 (control section 51) transmitting a status report or a job report (report of the type responsive to the collection type information) to the printer identification information of the printer 50 as a rule. The collection source printer identification information is information to prevent the information collection ticket from being repeatedly circulated between the printers 50 without transmitting a status report, a job report.

The report transmission processing (master report transmission processing and slave report transmission processing) executed by the control section 51 will be discussed in detail with flowcharts of FIGS. 12 to 16.

As previously described, the report transmission processing executed by the control section 51 is processing started when power of the printer 50 is turned on or when the status report transmission condition information, etc., is changed. If the status report transmission condition information, managed printer information, etc., is stored in the NVS (setting of the status report transmission condition information, managed printer information, etc., using the report transmission condition setting processing is performed), the master report transmission processing is started; otherwise, the slave report transmission processing is started.

The control section 51 starting the master report transmission processing operates according to the procedure shown in FIG. 11. The actual master report transmission processing is processing according to the procedure shown in FIG. 11 plus processing for transmitting an error report. However, the processing for transmitting an error report performed in the master report transmission processing is the same as that performed by the control section 11 in the printer 10 according to the first embodiment and therefore will not be discussed again. In the description that follows, the report of the type to be processed by the control section 51 (status report or job report) is denoted as the attention report for convenience of the description.

That is, the control section 51 starting the master report transmission processing first keeps track of (determines and stores) the status report transmission date and time of the transmission date and time of the next status report and the job report transmission date and time of the transmission date and time of the next job report from the setup status report transmission condition information and job report transmission condition information and the current date and time (step S201). At step S201, the control section 51 also reads managed printer information (several pieces of printer determination information) into RAM.

Next, the control section 51 transmits a command to the printers 50 determined by the group determination information read into the RAM (namely, the slave printers 50) to discard the information collection ticket received and not yet transferred (step S202).

The control section 51 starts to monitor occurrence of an issuance date and time event, a ticket reception event, a transmission success event, a transmission failure event, and a determination date and time event for each of status and job reports (step S203).

The issuance date and time event for a status report is an event that “the status report transmission date and time and the current date and time match in a state in which the information collection ticket for a status report (information collection ticket setting the collection information type indicating the information to be collected is status information) is unissued.” The issuance date and time event for a job report is an event that “the job report transmission date and time and the current date and time match in a state in which the information collection ticket for a job report (information collection ticket setting the collection information type indicating the information to be collected is job information) is unissued.”

The transmission success event for a status report, a job report is an event that “a report transmission completion notification (information indicating the type of transmitted report (described later in detail)) transmitted by the slave printer 50 (control section 51) completing transmission of a status report, a job report to the master printer 50 has been received before the date and time resulting from adding a predetermined time to the status report transmission date and time, the job report transmission date and time (hereinafter, denoted as the completion notification reception scheduled date and time for a status report, a job report).” The transmission failure event for a status report, a job report is an event that “a report transmission completion notification for a status report, a job report has not been received before the completion notification reception scheduled date and time for a status report, a job report.”

The ticket reception event for a status report, a job report is an event that “the information collection ticket for a status report, a job report, transmitted by a different printer 50 has been received.” The determination date and time event for a status report, a job report is an event that “the transmission determination date and time for a status report, a job report and the current date and time match in a state in which significant information is stored as the transmission determination date and time for a status report, a job report (described later in detail).”

Upon detection of occurrence of any of the events, the control section 51 exits step S203 and performs processing responsive to the detected event at steps S204 to S210.

Specifically, upon detection of occurrence of an issuance date and time event (steps S203 and S204; issuance date and time), the control section 51 performs ticket issuance processing at step S206.

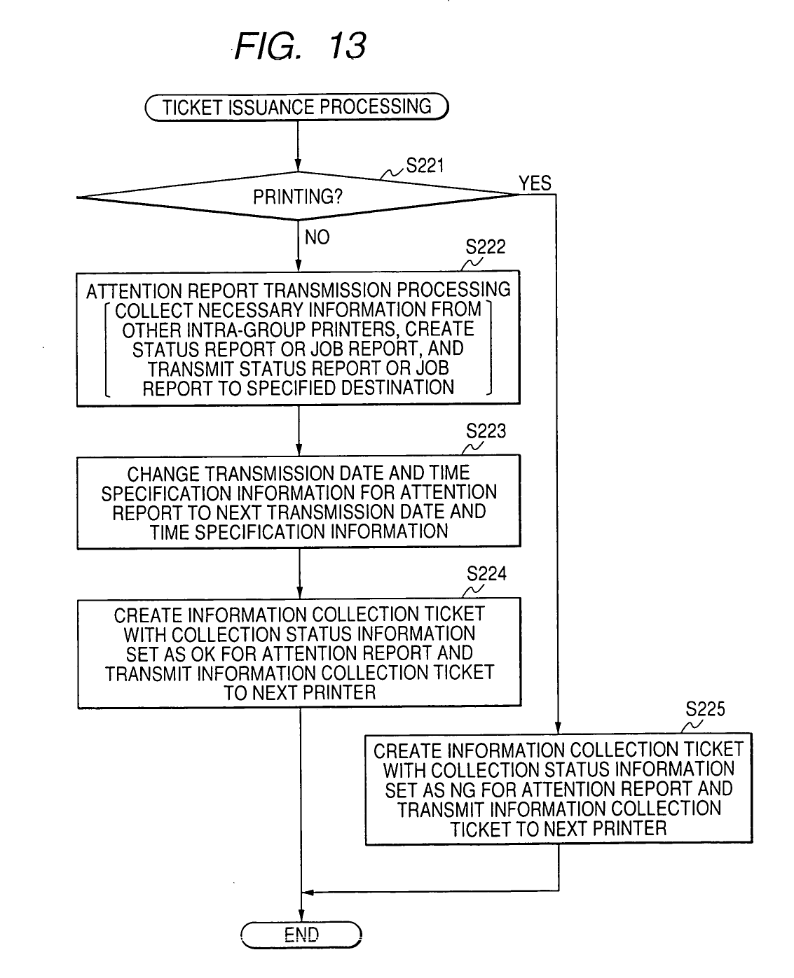

As shown in FIG. 13, at the time of the ticket issuance processing, the control section 51 first determines whether or not the printer is printing (performs print control processing for processing print job data) (step S221). If the printer is not printing (NO at step S221), the control section 51 performs attention report transmission processing (step S222). If the attention report is a status report (the ticket issuance processing is started because of occurrence of an event for a status report), the same processing as at steps S109 to S111 (FIG. 5) is performed as the attention report transmission processing; if the attention report is a job report (the ticket issuance processing is started because of occurrence of an event for a job report), the same processing as at steps S112 to S115 (FIG. 6) is performed as the attention report transmission processing.

Upon completion of the attention report transmission processing, the control section 51 changes the transmission date and time stored concerning the attention report (status report transmission date and time or job report transmission date and time) to the next status or job report transmission date and time and then creates an information collection ticket containing the collection information type and “OK” responsive to the attention report as the collection information type and collection status information, the printer identification information of the own printer 50 (in the embodiment, the IP address) as the collection source printer identification information, and information indicating the transmission date and time at the point in time for the attention report (in this case, the status or job report transmission date and time updated at step S223) as the transmission date and time specification information (any other information is as previously described with reference to FIG. 13) and transmits the information collection ticket to the next printer (step S224).

The “next printer” to which the information collection ticket is to be transmitted at step S224 and the “next printer” mentioned in the description to follow are used to mean the first printer 50 that can communicate with the own printer 50 in attempting to communicate with the own printer 50 in the order of the printer identification information contained in the intra-group printer specification information [the first printer 50 attempting to communicate with the own printer 50 is the printer 50 identified according to the printer identification information following the printer identification information of the own printer 50 (if the printer identification information of the own printer 50 is the end printer identification information, the printer 50 identified according to the top printer identification information)].

Although not shown in the flowchart, if the processing at step S224 resulted in failure in the master report transmission processing (if the created information collection ticket cannot be transmitted to a different printer 50), the created information collection ticket is handled as an information collection ticket received from a different printer 50 (as if a ticket reception event occurred).

Thus, if the printer is not printing at the start time of the ticket issuance processing, the processing section 51 transmits a status report or a job report to the specified destination and then terminates the ticket issuance processing.

In contrast, if the printer is printing at the start time of the ticket issuance processing (YES at step S221), the control section 51 performs only processing of creating an information collection ticket containing the collection information type and “NG” responsive to the attention report as the collection information type and collection status information, the printer identification information of the own printer 50 as the collection source printer identification information, and information indicating the transmission date and time for the attention report (information unchanged after determined at step S201) as the transmission date and time specification information and transmits the information collection ticket to the next printer (step S225) and then terminates the attention report transmission processing.

Slave report transmission processing will be discussed before the remaining description of the master report transmission processing is given.

The control section 51 starting the slave report transmission processing monitors occurrence of a ticket reception event, a determination date and time event for a status report, a job report (step S301), as shown in FIG. 15.

The ticket reception event and determination date and time event monitored at step S301 are the same as those monitored at step S203.

Upon detection of occurrence of a ticket reception event (steps S301 and 302; ticket reception), the control section 51 determines whether the collection status information in the received information collection ticket is “NG” or “OK” (step S303). If the collection status information is “OK” (OK at step S303), the control section 51 stores the date and time indicated by the transmission date and time specification information in the received information collection ticket as the transmission determination date and time for the attention report (report of the type indicated by the information collection type in the received information collection ticket) (step S305) and then again starts processing at step S301.

On the other hand, if the collection status information in the received information collection ticket is “NG” (NG at step S303), the control section 51 performs slave ticket transfer processing at step S304. If the control section 51 detects occurrence of a determination date and time event, the control section 51 also performs slave ticket transfer processing at step S304. Although not shown in the figure, upon detection of a determination date and time event (determination date and time at step S302), the control section 51 clears the transmission determination date and time for the determination date and time event so as to prevent occurrence of the same determination date and time event from being monitored in the later processing at step S203 and then performs the master ticket transfer processing.

As shown in FIG. 16, at the time of the slave ticket transfer processing, the control section 51 first determines whether or not the printer is printing (step S311). If the printer is not printing (NO at step S311), the control section 51 performs attention report transmission processing (step S312). The attention report transmission processing is the same as that executed at step S222 (FIG. 13).

Upon completion of the attention report transmission processing, the control section 51 transmits completion notification information containing information indicating the type of transmitted report to the master printer 50 (the printer 50 identified according to master printer identification information in the received information collection ticket) (step S313), changes the collection status information and the collection source printer identification information to “OK” and the printer identification information of the own printer 50, and changes the transmission date and time specification information to that indicating the date and time elapsed by the time indicated by the collection period specification information and then transfers the information collection ticket to the next printer (step S314) before terminating the slave ticket transfer processing. As seen from the fact that the slave ticket transfer processing is processing performed regardless of what the collection status information and the collection source printer identification information are, the processing at step S314 is processing wherein the collection status information and the collection source printer identification information may be unchanged (each information may be changed to the same information as the original).

On the other hand, if the printer is printing at the start time of the slave ticket transfer processing (YES at step S311), the control section 51 determines whether or not the collection source printer identification information in the received information collection ticket matches the identification information of the own printer (step S315). If they match (YES at step S315), the control section 51 transmits the information collection ticket with the collection status information and the collection source printer identification information changed to “NG” and the master printer identification information to the master printer 50 (step S316) and then terminates the slave ticket transfer processing. If the collection source printer identification information does not match the identification information of the own printer (NO at step S315), the control section 51 transmits the information collection ticket with the collection status information changed to “NG” to the next printer (step S317) and then terminates the slave ticket transfer processing. The processing at step S316, S317 is processing wherein the collection status information may be unchanged (the information may be changed to the same information as the original).

Upon completion of the slave ticket transfer processing, the control section 51 again starts the processing at step S301 (FIG. 15).

In short, if the printer is not printing (NO at step S311) upon reception of the information collection ticket with the collection status information set to “NG” (ticket reception at step S302 in FIG. 15 and NG at S303), immediately the control section 51 in the slave printer transmits an attention report (step S312 in FIG. 16) and notifies the master printer 50 that transmission of the attention report is complete (step S313). In this case, it is not necessary to cause a different printer 50 to immediately start transmission of the attention report and therefore the control section 51 transfers the information collection ticket with the collection status information set to “OK” and the transmission date and time specification information indicating the next attention report transmission date and time to the next printer.

On the other hand, if the printer is printing (YES at step S311) upon reception of the information collection ticket with the collection status information set to “NG” (ticket reception at step S302 and NG at S303) or if the printer is printing (YES at step S311) when the date and time become those indicated by the transmission date and time specification information in the information collection ticket (determination date and time at step S302) after reception of the information collection ticket with the collection status information set to “OK,” it is necessary to cause a different printer 50 to immediately transmit the attention report and therefore the control section 51 in the slave printer transmits the information collection ticket with the collection status information set to “NG” (information collection ticket with the unchanged transmission date and time specification information) to the next printer (steps S315 to S317). At the time, the fact that the collection source printer identification information matches the printer identification information of the own printer means that the information collection ticket transferred to the next printer is returned to the own printer without report transmission by a different printer 50 (if report transmission is executed by a different printer 50, the collection source printer identification information is rewritten) and therefore the process is caused to branch to S316 through S315 for causing the master printer to perform report transmission (described later in detail).

Referring again to FIG. 12, the description of the master report transmission processing is continued.

Upon detection of occurrence of a ticket reception event (ticket reception at steps S203 and S204), the control section 51 executing the master report transmission processing determines whether the collection status information in the received information collection ticket is “NG” or “OK” (step S208). If the collection status information is “OK” (OK at step S208), the control section 51 stores the date and time indicated by the transmission date and time specification information in the received information collection ticket as the transmission determination date and time for the attention report (report of the type indicated by the information collection type in the received information collection ticket) (step S210). The control section 51 again starts processing at step S203.

On the other hand, if the collection status information in the received information collection ticket is “NG” (NG at step S208), the control section 51 performs master ticket transfer processing at step S209. If the control section 51 detects occurrence of a determination date and time event (determination date and time at steps S203 and S204), the control section 51 also performs master ticket transfer processing at step S209. Although not shown in the figure, upon detection of a determination date and time event (determination date and time at steps S203 and 204), the control section 51 clears the transmission determination date and time for the determination date and time event and then performs the master ticket transfer processing.

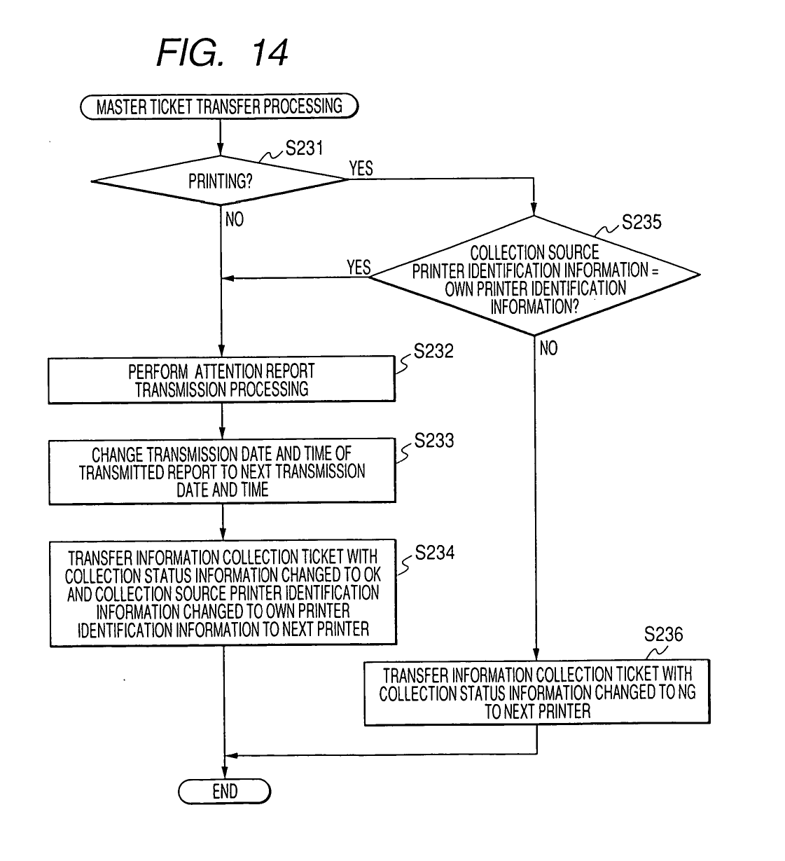

As shown in FIG. 14, at the time of the master ticket transfer processing, the control section 51 first determines whether or not the printer is printing (step S231). If the printer is not printing (NO at step S231), the control section 51 performs attention report transmission processing (step S232). The attention report transmission processing is the same as that executed at step S222, step S312.

Upon completion of the attention report transmission processing, the control section 51 changes the transmission date and time specification information for the attention report stored in the own printer to the next transmission date and time specification information (step S233) and transmits the information collection ticket with the collection status information and the collection source printer identification information changed to “OK” and the identification information of the own printer 50 (=master printer identification information) and the transmission date and time specification information changed to that for the attention report after change to the next printer (step S234) and then terminates the slave ticket transfer processing.

On the other hand, if the printer is printing at the start time of the master ticket transfer processing (YES at step S231), the control section 51 determines whether or not the collection source printer identification information in the received information collection ticket matches the identification information of the own printer 50 (step S235). If they match (YES at step S235), the control section 51 executes steps S232 to S234 as in the case where the printer is not printing, and then terminates the master ticket transfer processing.

In contrast, if the collection source printer identification information in the information collection ticket does not match the identification information of the own printer (NO at step S235), the control section 51 transmits the information collection ticket with the collection status information changed to “NG” to the next printer (step S236) and then terminates the master ticket transfer processing.

In short, the master ticket transfer processing results from modifying the slave ticket transfer processing so as to change the transmission date and time for the attention report (the transmission date and time information is not required in the slave ticket transfer processing in which occurrence of a transmission success event and a transmission failure event is not monitored) without transmitting transmission completion notification and so as to start report transmission processing even if the printer is printing upon reception of the information collection ticket transmitted at step S316 (FIG. 16).

Upon completion of the master ticket transfer processing, the control section 51 again starts the processing at step S203 (FIG. 12).

Upon detection of occurrence of a transmission success event (event of reception of transmission completion notification) (transmission success at steps S203 and S204), the control section 51 changes the transmission date and time (information managed by the control section 51) for the report of the type indicated in the transmission completion notification (in the figure, attention report) to the next report transmission date and time (step S207) and then again starts the processing at step S203. Upon detection of occurrence of a transmission failure event (event of reception of no transmission completion notification within the specified time) (transmission failure at steps S203 and S204), the control section 51 transmits a command to discard the information collection ticket for the report whose transmission failure event occurred (in the figure, attention report) to each intra-group printer (step S208) and then starts ticket issuance processing (step S206). The processing at step S207 is performed to prevent a plurality of information collection tickets from being circulated between the printers 50 if a transmission failure event occurs as a result of occurrence of any other phenomenon than a phenomenon in which power of the printer 50 receiving the information collection ticket with the collection status information set to “OK” is turned off before report transmission is executed (report transmission processing is not started or terminated for some reason).

The printer 50 according to the second embodiment is an apparatus which operates as described above. Thus, as the printer 50 is used, a network print system as previously described with reference to FIGS. 10A and 10B (as report transmission processing is performed, print job data processing is not delayed) can be constructed using a usual computer (a computer that can receive information using any of FTP, CIFS, or FTP) used intact as a printer management computer 100 (without installing an information collection program).

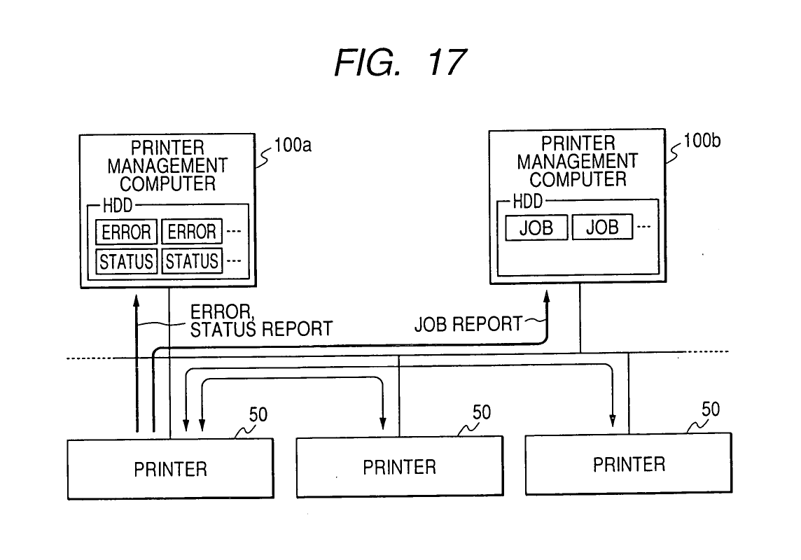

Like the printer 10, the printer 50 is also an apparatus for enabling the user to specify the report destination for each type of report. As the printer 50 is used, a system as schematically shown in FIG. 17, namely, a system wherein management for causing the printer 50 to operate in the normal state can be conducted using a printer management computer 100a and charging management can be conducted using a printer management computer 100b can also be constructed with usual computers used intact as the printer management computers 100a and 100b.

<Modifications>

The printer 10, 50 of the embodiment can be modified in various manners. For example, the status report transmitted by the printer 10, 50 of the embodiment contains information concerning consumables and information concerning any other than consumables, but the printer 10, 50 can be modified so as to transmit a status report containing information only concerning consumables and a status report containing information concerning any other than consumables. The printer 10, 50 may be modified so as to enable the user to specify only one report destination. However, if the printer 10, 50 is thus modified, it is made impossible to construct the system as shown in FIG. 8, FIG. 17 and therefore it is desirable that the above-described configuration should be adopted.

The printer 10, 50 does not enable the user to specify the contents of an error report (the types of information contained in an error report), but may be modified so as to enable the user to specify the contents of an error report. To thus modify the printer 10, 50, the report transmission condition set page (FIG. 2) may be provided with several check boxes for the user to specify whether or not specific information, such as information concerning the toner remaining amount or information concerning a jam that occurred, is to be contained in an error report (or a select box 21 providing a larger number of selectable values).

The printer 10, 50 may be modified to an apparatus which does not enable the user to specify a protocol (an apparatus for transmitting a report using the FTP or CIFS). However, if the printer 10, 50 is thus modified, the specifications of the computer for receiving reports are limited and therefore it is desirable that the printer 10, 50 should be as described above.

The printer 10, 50 transmits a report concerning a different printer and a report concerning the own printer 10, 50, but may be modified so as to transmit one report (file) concerning a different printer and the own printer 10, 50. The printer 10, 50 may be modified so as to enable the user to specify the format of the report to be transmitted (for example, plain text, CSV format text, or XML).

The report transmission condition information setting processing executed by the own printer 10, 50 is processing for prompting the user to set various pieces of information by providing the report transmission condition set page and the managed printer selection page, but may be modified to processing of accepting specification of information indicating the location of the file containing the error report transmission condition information (for example, computer name and full path file name, printer name and file name) and reading the contents of the file specified by the information.

The master printer 50 can also be modified to an apparatus for searching for a slave printer 50 not printing and instructing the found slave printer 50 to perform report transmission processing if the master printer 50 is printing when the report transmission date and time is reached.

The printer 50 may be modified so that transfer of an information collection ticket is continued until any printer 50 enters a non-printing state. Further, the printer 50 may be modified so that information having a structure different from that described above is circulated as an information collection ticket. That is, the information collection ticket may be any if it informs the printer 50 receiving the information collection ticket of the date and time to transmit a report. Thus, for example, the information collection ticket may contain the intra-group printer specification information, the master printer identification information, the transmission date and time specification information, and the collection period specification information and the printer 50 may be modified so as to transfer the information collection ticket to the next printer if the printer 50 is printing when receiving the information collection ticket; if the printer 50 is not printing, so as to continue to hold the information collection ticket after transmitting a report, and perform the same operation as at the reception time at the next report transmission time (the date and time are found from the transmission date and time specification information and the collection period specification information).

The printer 10, 50 has the RTC, but may be modified to an apparatus for adjusting the time by communicating with another apparatus keeping track of the accurate date and time (an NTP (Network Time Protocol) server, a computer having an RTC, a computer adjusting the time at regular time intervals using an NTP server, or the like) without having the RTC.

1. A network print system comprising:
a first-kind printer;
one or more second-kind printers; and
a printer management computer,
wherein said second-kind printer includes a request response section for returning printer state information representing an own state at the point in time to an apparatus transmitting predetermined request information, and
wherein said first-kind printer includes:
(1) an information storage section for storing (1-1) transmission schedule information for specifying a transmission schedule of printer state management information which represent an own state and the state of each of said one or more second-kind printers, and (1-2) address information of each of said one or more second-kind printers; and
(2) a printer state management information transmission section for (2-1) repeating process of acquiring the printer state information from said second-kind printer determined by the address information stored in the information storage section by transmitting the predetermined request information, (2-2) creating the printer state management information based on the acquired printer state information and printer state information concerning the own printer, and (2-3) transmitting the printer state management information to said printer management computer in accordance with the transmission schedule specified in the transmission schedule information stored in the information storage section.

2. The network print system as claimed in claim 1,
wherein the printer state management information transmission section transmits text information as the printer state management information.

3. The network print system as claimed in claim 1,
wherein the printer state management information transmission section transmits files generated on a printer-by-printer basis as the printer state management information.

4. The network print system as claimed in claim 1,
wherein the printer state management information transmission section enables an user to select the protocol used to transmit the printer state management information from among protocols.

5. A network print system comprising:
a plurality of printers; and
a printer management computer,
wherein each of said plurality of printers include:
(1) a printer state information return section for returning printer state information which represent an own state at the point in time, to an apparatus transmitting predetermined request information; and
(2) a printer state management information transmission section for (2-1) acquiring the printer state information from each of other printers by transmitting the predetermined request information to the printer state information return section in each of other printers, and (2-2) transmitting printer state management information responsive to the acquired printer state information of the other printers and own printer state information, to said printer management computer, and
wherein at least one of said plurality of printers further includes an operation control section for repeating control to cause only the printer state information transmission section in the printer not printing among said plurality of printers to operate in accordance with a specified transmission schedule.

6. The network print system as claimed in claim 5,
wherein the printer state management information transmission section transmits text information as the printer state management information.

7. The network print system as claimed in claim 5,
wherein the printer state management information transmission section transmits files generated on a printer-by-printer basis as the printer state management information.

8. The network print system as claimed in claim 5,
wherein the printer state management information transmission section enables an user to select the protocol used to transmit the printer state management information from among protocols.

9. The network print system as claimed in claim 5,
wherein each of said plurality of printers include the operation control section, and
wherein the operation control section of each of is said plurality of printers:
1) circulates processing description specification information indicating the date and time to cause the printer state information transmission section to operate among the operation control section of said plurality of printers,
2) determines whether or not the own printer is processing print job data at the date and time indicated by the received processing description specification information,
3) if the own printer is not processing print job data, causes the printer state information transmission section in the own printer to operate and then transferring processing description specification information indicating the next date and time to cause the printer state information transmission section to operate to another printer, and
4) if the own printer is processing print job data, transfers the received processing description specification information to another printer.

10. A printer being connected to a network for use, said printer comprising:
a printer state information return section for returning printer state information which represent an own state at the point in time, to an apparatus transmitting predetermined request information;
a printer state management information transmission section for acquiring the printer state information from each of other printers by transmitting the predetermined request information to each printer having printer state information return section, and transmitting printer state management information responsive to the acquired printer state information and printer state information concerning the own printer, to a printer management computer connected to the network; and
an operation control section for performing control to start operation of said printer state information transmission section,
wherein said operation control section:
1) circulates processing description specification information indicating the date and time to cause said printer state information transmission section to operate among the operation control section in other printers connected to the network,
2) determines whether or not the own printer is processing print job data at the date and time indicated by the received processing description specification information,
3) if the own printer is not processing print job data, causes said printer state information transmission section in the own printer to operate and then transfers processing description specification information indicating the next date and time to cause said printer state information transmission section to operate to another printer, and
4) if the own printer is processing print job data, transfers the received processing description specification information to another printer.

11. The printer as claimed in claim 10,
wherein said printer state management information transmission section transmits text information as the printer state management information.

12. A network pint system comprising:
a plurality of printers;
a printer management computer,
wherein, one printer in standby state among the plurality of printers operates as a master printer which, in accordance with a predetermined schedule, prepares a master report by collecting the status information of the other printers and the own status information and transmits the master report to the printer management computer.

13. The network print system as claimed in claim 12,
wherein, among said plurality of printers, information indicating the predetermined schedule is circulated.

14. The network print system as claimed in claim 12,
wherein, if a printer in standby state receives the information indicating the predetermined schedule, the printer operates as the master printer, and
wherein, if a printer in printing state receives the information indicating the predetermined schedule, the printer transfers the information to a next printer.
